(19) United States
(12) Patent Application Publication
(10) Pub. No.: US 2008/0230191 A1
(43) Pub. Date: Sep. 25, 2008

(54) Roller Clutch Assembly

(76) Inventors: Philip Ng, Thornhill (CA); Norman Wills, Mississauga (CA)

Correspondence Address: Elias Borges, Suite 406, 555 Burnhamthorpe Road, Toronto, ON, M9C 2Y3, CA

(21) Appl. No.: 11/972,148

(22) Filed: Jan. 10, 2008

Related U.S. Application Data
(60) Provisional application No. 60/880,017, filed on Jan. 12, 2007.

(51) Int. Cl. E06B 9/56

(52) U.S. Cl. 160/305

(57) ABSTRACT

The present invention is a roller clutch assembly for a roller blind which operates smoothly and quietly. The roller clutch assembly includes an elongated roller tube having first and second opposite ends and a clutch coaxially mounted to the first end of the tube. The clutch has a peripheral section rotatably mounted to a fixed hub, the peripheral section being mounted to the tube such that the tube is free to rotate. The assembly also includes an elongated rod mounted within the roller tube, the rod having opposite first and second ends, the first end of the rod being mounted to the hub of the clutch. A mount is rotatably attached to the second end of the rod for mounting the rod within the tube such that the tube and rod are substantially coaxially aligned. A coil spring is coaxially mounted onto the elongated rod, the coil spring having opposite first and second ends, the first end of the spring being fixed to the rod adjacent the first end of the rod, the second end of the spring being fixed to the mounting adaptor such that the spring can be wound and unwound on the rod by rotating the tube. The spring is stretched onto the rod sufficiently such that the spring does not kink when wound.

### CROSS REFERENCE TO RELATED APPLICATION

This application claims priority from U.S. provisional patent application Ser. No. 60/880,017 filed Jan. 12, 2007, the entirety of which is incorporated herein by reference.

### FIELD OF THE INVENTION

The invention relates generally to spring loaded roller clutch assemblies for roller blinds.

### BACKGROUND OF THE INVENTION

Spring loaded clutch assemblies for use with roller blinds are well known in the art. These clutch assemblies generally include a roller tube for taking up the blind and a clutch for winding the roller tube. A long coil spring is usually disposed inside the roller tube to permit a spring assist when pulling up the roller blind. While such spring loaded clutch assemblies are popular, they suffer from one annoying problem, namely such spring loaded clutch assemblies tend to rattle as they are rolled up and down. The rattle is due to the spring being not fully supported within the roller tube and/or kinking. As a result, the spring loading mechanism has a tendency to hit against the roller tube during operation, causing a rattling sound. An improved roller design which permits the smooth and rattle free operation of the blind is therefore desirable.

### SUMMARY OF THE INVENTION

In accordance with one aspect of the present invention, there is provided a roller clutch assembly for a roller blind which overcomes the disadvantages of the prior art by providing smooth and quite operation. The roller clutch assembly includes an elongated roller tube having first and second opposite ends and a clutch coaxially mounted to the first end of the tube. The clutch has a peripheral section rotatably mounted to a fixed hub, the peripheral section being mounted to the tube such that the tube is free to rotate. The assembly also includes an elongated rod mounted within the roller tube, the rod having opposite first and second ends, the first end of the rod being mounted to the hub of the clutch. A mount is rotatably mounted on the second end of the rod for mounting the second end of the rod securely within the tube. A coil spring is coaxially mounted onto the elongated rod, the coil spring having opposite first and second ends, the first end of the spring being fixed to the rod adjacent the first end of the rod, the second end of the spring being fixed to the mounting adaptor such that the spring can be wound and unwound on the rod by rotating the tube.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is an exploded side view of a roller clutch assembly made in accordance with the present invention.

FIG. 2 is a side view of the roller clutch assembly made in accordance with the present invention partly in cross section.

FIG. 3 is a side view of a prior art spring assist assembly contained within a roller tube.

FIG. 4 is a close up view of part of FIG. 1.

FIG. 5 is a side view of a coil spring for use with the present invention.

FIG. 6 is a side view of the spring shown in FIG. 5 which has been stretched.

In the drawings like characters of reference indicate corresponding parts in the different figures.

### DETAILED DESCRIPTION OF THE INVENTION

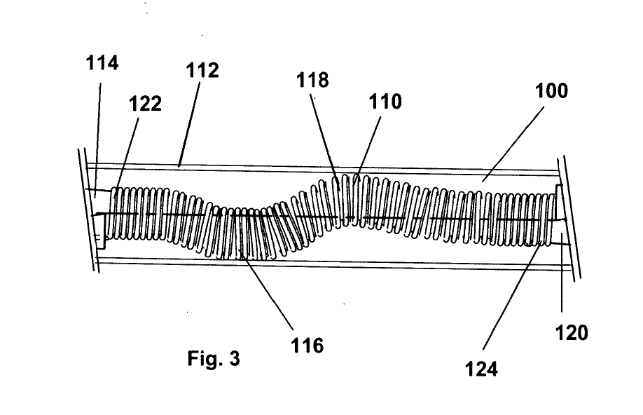

Referring firstly to FIG. 3, prior art spring assist assemblies, shown generally as item 100, consisted of an elongated coil spring 110 which was mounted within a roller tube 112 mounted between clutch 114 and support 120. The coil spring had opposite ends 122 and 124 which were attached to clutch 114 and support 120, respectively. As the roller tube 112 was rotated, coil spring 110 would be either wound (loaded) or unwound (unloaded) depending on the direction the tube was rotated. Generally, the spring was mounted in the tube such that the spring was loaded (coiled up) as the blind (not shown) wrapped onto the tube was lowered and unloaded as the blind was raised. As the spring is coiled it has a tendency to kink as shown in FIG. 3. Kinks 116 and 118 tend to bulge out and make contact with tube 112, causing an annoying clinking sound as the blind is lowered or lifted. The present invention overcomes this disadvantage by providing a design which keeps the spring coaxially aligned with the tube and prevents it from kinking.

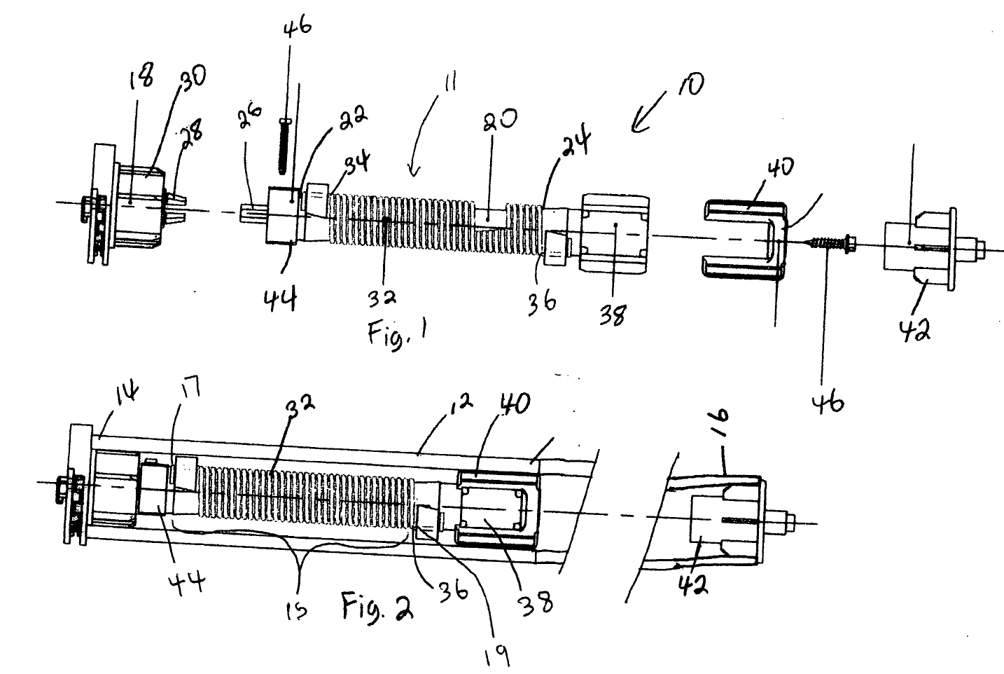

Referring now to FIGS. 1 and 2, the present invention consists of a roller clutch assembly, shown generally as item 10 having an elongated hollow tube 12 having opposite first end 14 and second end 16. Roller clutch 18 is mounted on first end 14 of the tube. Contained within tube 12 is a spring assist assembly 11. Spring assist assembly 11 includes an elongated bar 20 having opposite ends 22 and 24. End 22 of bar 20 has sleeve 44 which has connector element 26 which is configured to rigidly attach to hub 28 of clutch 18. Clutch 18 is a standard roller blind clutch having a stationary hub 28 and a periphery 30 which rotates about the stationary hub. Coiled around bar 20 is coil spring 32 which has opposite first end 34 and second end 36.

Sleeve 38 is rotatably mounted to end 24 of bar 20 such that sleeve 38 can rotate about bar 20. End 34 of spring 32 is mounted to sleeve 44 which is in turn mounted onto bar 20. Sleeve 44 is held in place by screw 46 such that sleeve 44 is secured to the bar. End 36 of spring 32 is mounted to sleeve 38, which is in turn rotatably mounted onto bar 20 such that when sleeve 38 is rotated, spring 32 is either wound (loaded) or unwound (unloaded), depending in which direction sleeve 38 is rotated. Coil spring 32, when un-sprung, is preferably shorter than distance 15, which is the distance between attachment point 17 where end 34 of the spring is mounted to bar 20 and point 19 where end 36 is mounted to sleeve 38. Since the unsprung length of spring 32 is less than distance 15, spring 32 is stretched onto the bar. As will be discussed later, stretching the coil spring in this way prevents the spring from kinking as it is loaded.

Adaptor 40 is mounted onto sleeve 38 and is dimensioned and configured such that the adaptor fits snugly into tube 12 and onto sleeve 38 such that the adaptor physically couples tube 12 to sleeve 38. Preferably, adaptor 40 has an outside diameter equal to the inside diameter of tube 12 and to the outside diameter of peripheral portion 30 of clutch 18 so that the tube fits snugly onto peripheral portion 30 and adaptor 40. Adaptor 40 is secured to rod 20 by mounting screw 46. Clutch idle end 42 is mounted to end 16 of tube 12.

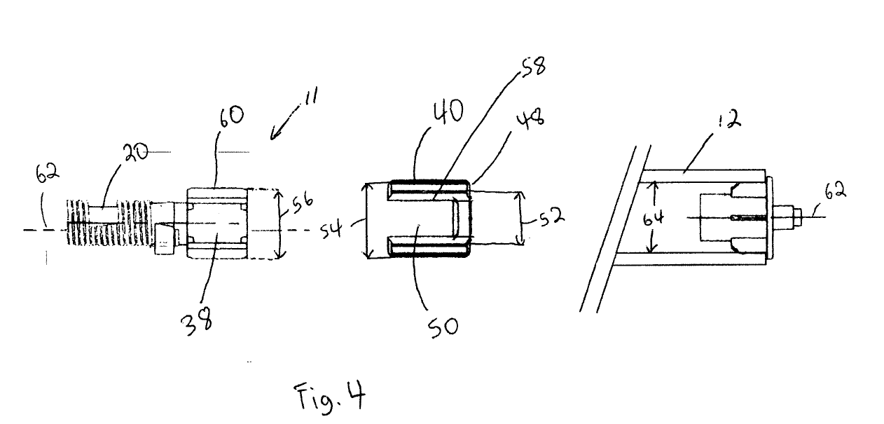

Referring now to FIG. 4, adaptor 40 has an outside portion 48 and an inside cavity 50. Inside cavity 50 is dimensioned and configured to receive sleeve 38 such that the sleeve is physically coupled to adaptor 40. Preferably, the inside diameter 52 of cavity 50 is equal to or slightly greater than the outside diameter 56 of sleeve 38 such that the sleeve can fit snugly within adaptor 40. Outside surface 60 of sleeve 38 and inside surface 58 of adaptor 40 are preferably configured to have convolutions or veins which ensure that sleeve 38 and adaptor 40 are securely coupled to one another such that rotation of adaptor 40 about axis 62 causes sleeve 38 to rotate in kind. The outside diameter 54 of adaptor 40 is selected to be approximately equal to of slightly less than the inside diameter 64 of tube 12 such that the adaptor fits snugly within the tube. It will be appreciated that spring assist assembly 11 can be used with a variety of different sized tubes simply by using adaptors having appropriately dimensioned outside diameters.

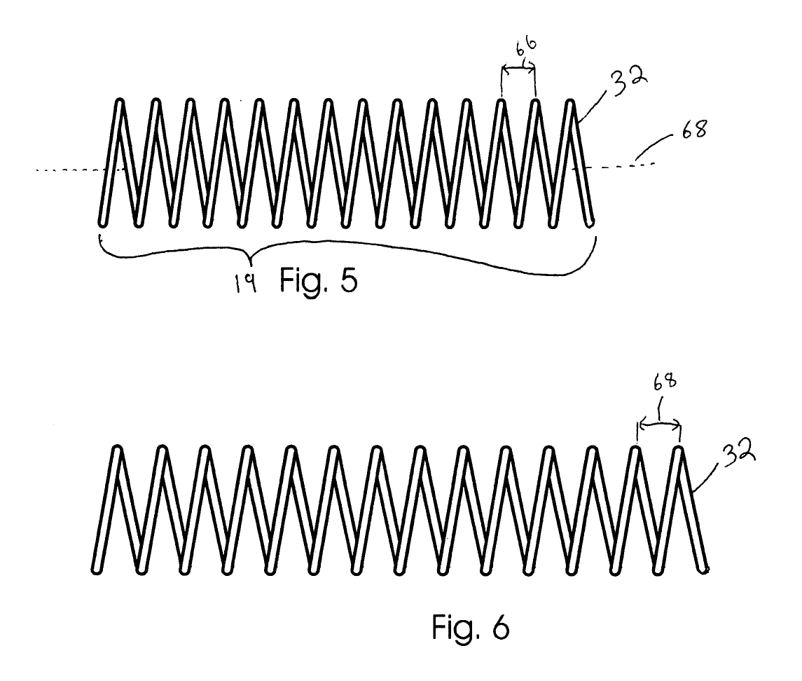

Referring now to FIGS. 5 and 6, coil spring 32 is an elongated coil spring configured to be loaded and unloaded by winding and unwinding, respectively, about axis 68. Spring 32 has an un-stretched length 19, which is the length of the spring under no load conditions. As seen in FIG. 5, coil spring 32 has a pitch of 66 when the spring is unloaded and not stretched. Stretching spring 32, as shown in FIG. 6, causes the length of the spring to increase and also causes the spring's pitch 68 to increase. It has been discovered that stretching the spring increases the spring's pitch and decreases the likelihood that the spring will kink when it is wound (loaded). Preferably, when mounted in the spring assembly, the coil spring is stretched sufficiently such that the spring will not kink when fully loaded.

The operation of the present invention will now be discussed with reference to FIGS. 1 and 2. As clutch 18 is engaged to rotate tube 12, coil spring 32 is either wound or unwound. Clutch 18 is configured such that as the user unrolls the blind (not shown) which is attached to tube 12, coil spring 32 is wound up and the tension in the coil increases. Rolling up the blind by engaging the clutch causes the coil spring to unwind. Since the coil spring is being unwound, the coil spring assists in rotating tube 12, thereby providing the user with assistance in rolling up the blind. Hence, rod 20, coil spring 32 and sleeve 38 form a spring assist assembly 11 for the clutch assembly which fits neatly inside roller tube 12. Coil spring 32 is supported at its first end 34 by attachment to sleeve 44 which is in turn mounted to rod 22 which is fixed in place on hub 28 of clutch 18. End 36 of the coil is supported by attachment to rotating sleeve 38 which is in turn coupled to tube 12 via adaptor 40. Hence, both ends of the coil spring are supported and the coil itself is supported by rod 20. As a result, as the blind is raised or lowered, the spring loaded recoil mechanism operates smoothly and silently since the spring loaded mechanism, being supported on both ends, does not rattle against tube 12. Also, since spring 32 is shorter than rod 20 and is stretched onto the rod, the spring does not form kinks as the spring is wound up. The lack of kinks on spring 32 results in smoother and more quite operation of the mechanism.

Adaptor 40 permits the spring loaded recoil mechanism to be used with a variety of different sized roller clutches and clutch tubes. For clutches and roller tubes having larger diameters, an adaptor having a larger diameter is used. Hence, the spring assist assembly 11 may be used with a variety of differently sized clutches and tubes simply by selecting the correctly sized adaptor 40.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A roller clutch assembly for a roller blind comprising:
an elongated roller tube having first and second opposite ends;
a clutch coaxially mounted to the first end of the tube, the clutch having a peripheral section rotatably mounted to a fixed hub, the peripheral section being mounted to the tube such that the tube is free to rotate;
an elongated rod mounted within the roller tube, the rod having opposite first and second ends, the first end of the rod being mounted to the hub of the clutch;
a mount attached to the second end of the rod for mounting the second end of the rod within the tube;
a coil spring coaxially mounted to the elongated rod, the coil spring having opposite first and second ends, the first end of the spring being fixed to the rod at a first attachment point adjacent the first end of the rod, the second end of the spring being fixed to the mount at a second attachment point, and
the mount being rotatably mounted to the rod such that the spring can be wound and unwound by rotating the tube.

2. The roller clutch assembly of claim 1 wherein the mount has an outside diameter selected such that the mount fits snugly within the tube.

3. The roller clutch assembly of claim 1 wherein the mount comprises a sleeve rotatably mounted to the rod adjacent the second end of the rod and an adaptor member mounted to the sleeve, the adaptor member dimensioned to mount the sleeve within the tube.

4. The roller clutch assembly of claim 3 wherein the adaptor has an outside diameter selected such that the adaptor fits snugly within the tube.

5. The roller clutch assembly of claim 4 wherein the adaptor has a cavity dimensioned to receive the sleeve.

6. The roller clutch assembly of claim 5 wherein the sleeve has an external diameter and wherein the cavity has an internal diameter, the internal diameter of the adaptor's cavity and the external diameter of the sleeve being selected to permit the sleeve to fit within the adaptor.

7. The roller clutch assembly of claim 3 wherein the adaptor and sleeve are physically coupled to one another such that the rotation of the tube induces rotation of the sleeve.

8. The roller clutch assembly of claim 3 wherein the second end of the coil spring is mounted to the sleeve.

9. The roller clutch assembly of claim 1 wherein the spring is stretched sufficiently to prevent the spring from kinking as it is wound.

10. The roller clutch assembly of claim 1 wherein the first and second attachment points are separated by a distance and wherein the spring has an unstretched length selected to be sufficiently less than the distance such that the spring does not kink as it is wound.

11. A roller clutch assembly for a roller blind comprising:
an elongated roller tube having first and second opposite ends;
a clutch coaxially mounted to the first end of the tube, the clutch having a peripheral section rotatably mounted to a fixed hub, the peripheral section being mounted to the tube such that the tube is free to rotate;
an elongated rod mounted within the roller tube, the rod having opposite first and second ends, the first end of the rod being mounted to the hub of the clutch;
a mount attached to the second end of the rod for mounting the second end of the rod within the tube such that the rod and tube are substantially coaxially aligned;
a coil spring coaxially mounted on to the elongated rod, the coil spring having opposite first and second ends and an unsprung length, the first end of the spring being fixed to the rod at a first attachment point adjacent the first end of the rod, the second end of the spring being fixed to the mount at a second attachment point;
the mount being rotatably mounted to the rod such that the spring can be wound and unwound on the rod by rotating the tube; the spring having a pitch, and
the pitch of the spring being increased by stretching the spring onto the rod sufficiently to prevent the spring from kinking as it is wound on the rod.

12. The roller clutch assembly of claim 11 wherein the mount comprises a sleeve rotatably mounted to the rod adjacent the second end of the rod and an adaptor member mounted to the sleeve, the adaptor member dimensioned to mount the sleeve securely within the tube.

13. The roller clutch assembly of claim 12 wherein the adaptor member has an outside diameter dimensioned such that the adaptor member fits snugly within the tube.

14. The roller clutch assembly of claim 13 wherein the adaptor member has a cavity dimensioned to receive the sleeve.
